(19) United States
(12) Patent Application Publication
(10) Pub. No.: US 2016/0351948 A1
(43) Pub. Date: Dec. 1, 2016

(54) LITHIUM-ION BATTERY COMPRISING A LITHIUM-RICH CATHODE AND A GRAPHITE-BASED ANODE

(71) Applicant: RENAULT S.A.S., Boulogne-Billancourt (FR)

(72) Inventors: Irina PROFATILOVA, Grenoble (FR); Lise DANIEL, Saint-Marcellin (FR)

(73) Assignee: RENAULT s.a.s., Boulogne-Billancourt (FR)

(21) Appl. No.: 15/117,962

(22) PCT Filed: Feb. 10, 2015
(86) PCT No.: PCT/FR15/50313

§ 371 Date: Aug. 10, 2016

(30) Foreign Application Priority Data
Feb. 11, 2014 (FR) 1451054

(51) Int. Cl. H01M 10/0525; H01M 10/0568; H01M 10/058; H01M 4/133; H01M 4/131; H01M 10/44; H01M 4/1391; H01M 4/505; H01M 4/525; H01M 4/62; H01M 4/04; H01M 10/0569; H01M 4/1393

(52) U.S. Cl. CPC H01M 10/0525; H01M 10/0569; H01M 10/0568; H01M 10/058; H01M 4/133; H01M 4/131; H01M 4/1393; H01M 4/1391; H01M 4/505; H01M 4/525; H01M 4/623; H01M 4/622; H01M 4/625; H01M 4/0404; H01M 10/446; H01M 2010/4292

(57) ABSTRACT

A lithium-ion battery includes a graphite-based material for negative electrode, a lithium-rich material for positive electrode, an electrolyte and a separator. The reversible capacity (N) of the negative electrode is equal to the reversible capacity (P) of the positive electrode so that the battery exhibits a ratio N/P=1.

The invention relates to the general field of rechargeable lithium-ion batteries.

More specifically, the invention relates to the rechargeable lithium-ion batteries comprising a lithium-rich material for a positive electrode and a graphite-based material for a negative electrode.

The invention also relates to a process for the preparation of lithium-ion batteries comprising said electrodes.

Finally, the invention relates to a process for cycling lithium-ion batteries comprising such electrodes, with moderate capacities which make it possible to improve the lifetime of a lithium-ion battery cell.

Conventionally, Li-ion batteries comprise one or more positive electrode(s), one or more negative electrode(s), an electrolyte and a separator composed of a porous polymer or of any other appropriate material in order to avoid any direct contact between the electrodes.

Li-ion batteries are increasingly used as an autonomous energy source, in particular in applications related to electric mobility. This trend is explained in particular by mass and volume energy densities which are markedly greater than those of conventional nickel-cadmium (Ni—Cd) and nickel-metal hydride (Ni-MH) batteries, an absence of memory effect, low self-discharge in comparison with other batteries and also a fall in the costs at the kilowatt-hour related to this technology.

Materials based on carbon, in particular on graphite, have been successfully developed and have been widely commercialized as electrochemically active materials of negative electrodes for Li-ion batteries. These materials are particularly effective as a result of their structure, which is favorable to the intercalation and the deintercalation of lithium, and of their stability during the different charge and discharge cycles.

The Li-ion batteries comprising graphite-based materials for a negative electrode are generally designed so that the reversible capacity (N) of the negative electrode is greater than the reversible capacity (P) of the positive electrode (P. Arora and R. E. White. Capacity fade mechanism and side reactions in lithium-ion batteries. J. Electrochem. Soc., Vol. 145 (1998), 3647-3667; B. Son, M.-H. Ryou, J. Choi, S.-H. Kim, J. M. Ko and Y. M. Lee. Effect of cathode/anode area ratio on electrochemical performance of lithium-ion batteries. J. Power Sources, Vol. 243 (2013), 641-647; Y. Li, M. Bettge, B. Polzin, Y. Zhu, M. Balasubramanian and D. P. Abraham. Understanding Long-Term Cycling Performance of Li_{1.2}Ni_{0.15}Mn_{0.55}Co_{0.1}O₂-Graphite Lithium-Ion Cells. J. Electrochem. Soc., 160 (5), A3006-A3019 (2013)). An N/P ratio is then defined.

The batteries thus designed exhibit an N/P ratio >1 (1.05-1.3). Thus, excess graphite is placed in the cell in order to prevent the plating of lithium at the negative electrode during the charge and discharge cycles, which results in degradation of the battery. However, this excess of graphite leads to a decrease in the specific energy density of the cell.

In order to deal with these problems, batteries exhibiting N/P ratios <1 have been designed which comprise a material for a negative electrode based on lithium titanate (Li₄Ti₅O₁₂, LTO), as is described in the following documents US2009/0035662, US2011/0281148 and US2013/164584.

The material based on LTO is a material for a negative electrode well known to a person skilled in the art which has several specific characteristics. When it is of spinel structure, it exhibits a high operating voltage of approximately 1.5 V and a low theoretical specific capacity of 175 mAh/g. In comparison with graphite, which exhibits an operating voltage of approximately 0.15 V and a theoretical specific capacity of 372 mAh/g, the material based on LTO thus exhibits a reduced energy density. By virtue of the high operating voltage and as a result of the absence of SEI layer at the surface of this electrode, there is no risk of plating of lithium at the surface of the Material based on LTO. On the other hand, the lithiation of the graphite can result in a deposit of lithium metal during the formation of the “SEI” layer. Thus, it is not possible to conceive of batteries exhibiting an N/P ratio <1 when the material of the negative electrode is based on graphite.

Furthermore, the material based on LTO is generally used as material of nanometric size in order to achieve high intercalation/deintercalation kinetics for lithium ions. High-power applications are thus appropriate but the associated cost is high. For its part, the graphite is used as material of micronic or submicronic size and is generally cheaper than the material based on LTO.

Another issue linked to Li-ion batteries relates to the ability of said batteries to withstand the repetition of the charge and discharge cycles, which involve a deep discharge, that is to say close to 0 volt (V). These charge and deep discharge cycles can reduce the full accessible capacity of said batteries. For example, a battery which has an initial charge of 3 V can, after 150 charge and deep discharge cycles, have a full accessible capacity markedly lower than the initial capacity.

One consequence of this weakening in capacity is the need to frequently recharge the battery, which is not very practical for the user.

The charge and discharge cycles are also the cause of another phenomenon. Products resulting from the thermodynamic reactions which take place within an Li-ion battery accumulate on the surface of the active material to form a layer known as “Solid Electrolyte Interphase” (SEI). This SEI is a component essential to the satisfactory operation of the Li-ion battery, although responsible for the high irreversible capacity observed during the first cycle, as it not only very well conducts the lithium ions but also exhibits the advantage of stopping the catalytic decomposition of the solvent.

It would thus be advantageous to provide a Li-ion battery cell comprising materials for electrodes making it possible both to avoid the problems related to the plating of lithium and to increase the resistance to the weakening in capacity.

It has now been discovered that a specific process for the cycling of a Li-ion battery, exhibiting an N/P ratio=1 and comprising a graphite-based material for a negative electrode, resulted in an electrochemical performance being obtained which is similar to those of Li-ion batteries comprising said same material for a negative electrode and exhibiting an N/P ratio of >1. The immense advantage lies in the fact that the excess of graphite is no longer necessary, consequently resulting in an increase in the energy density of the cell.

After a first cycle of activation of the lithium-rich material for a positive electrode at a voltage >4.4 V, the following charge and discharge cycles take place at reduced voltages and using a reduced capacity C, C denoting the capacity of the Li-ion battery. This specific cycling process is known from the prior art, as shown by the document US 2012/0056590, which describes said process for Li-ion batteries comprising a lithium-rich material for a positive electrode and a material for a negative electrode which can intercalate lithium.

A subject matter of the invention is thus a lithium-ion battery comprising a graphite-based material for a negative electrode, a lithium-rich material for a positive electrode, a separator and an electrolyte, the reversible capacity (N) of said negative electrode being equal to the reversible capacity (P) of said positive electrode so that said battery exhibits an N/P ratio=1, the N/P ratio being defined by the equation (1) as described below. In the continuation of the present patent application, “lithium-rich material for a positive electrode” is understood to mean any lamellar oxide of general formula:

xLi₂MnO₃.(1−x)LiMO₃

where M represents one or more transition elements.

Another subject matter of the invention is a process for the preparation of Li-ion batteries according to the invention.

A final subject-matter of the invention is a specific cycling process for the batteries according to the invention.

Other advantages and characteristics of the invention will become more clearly apparent on examining the detailed description and the appended drawings, in which:

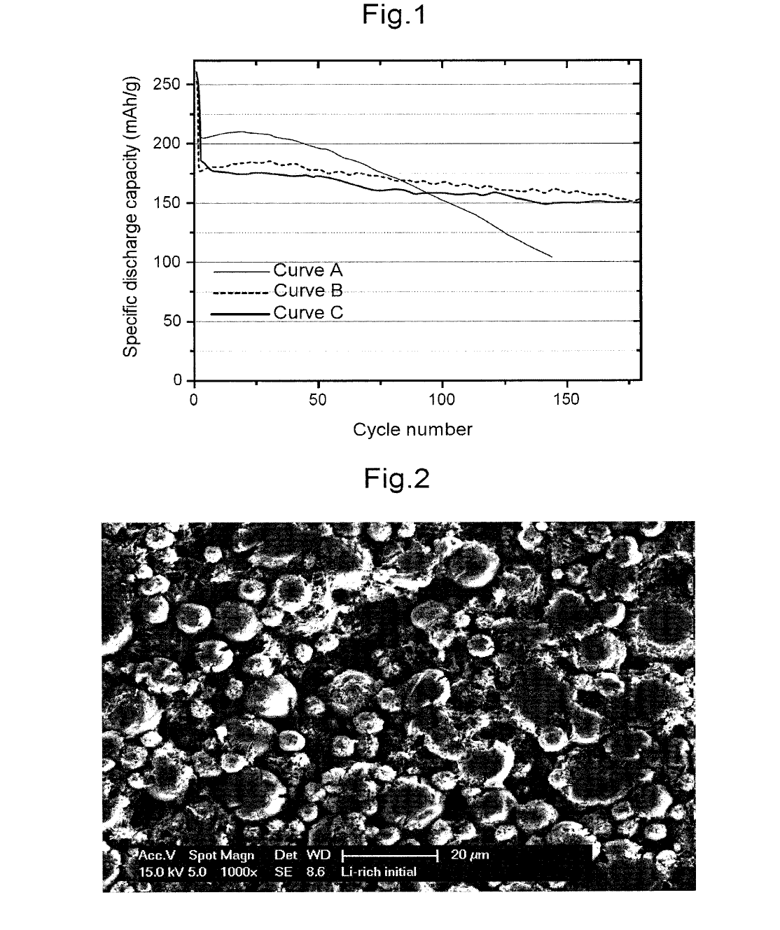

FIG. 1 compares the specific discharge capacities of cells of Li-ion batteries exhibiting different N/P ratios as a function of the charge and discharge cycle number,

FIG. 2 represents a scanning electron microscope photograph of a lithium-rich material for a positive electrode,

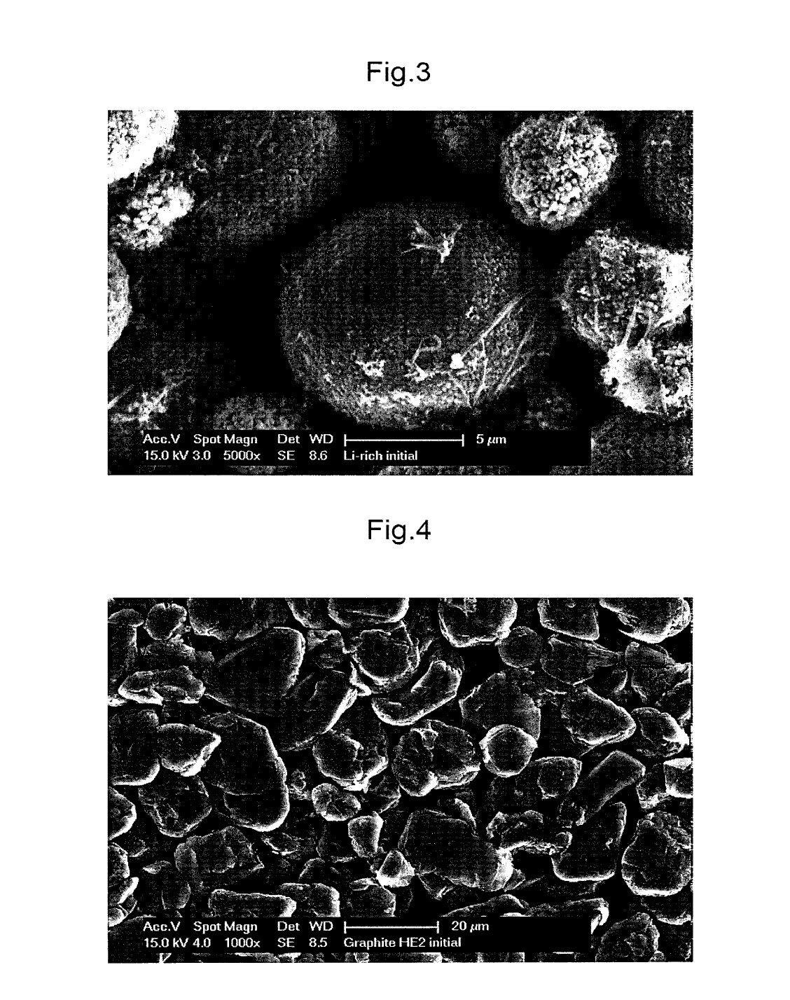

FIG. 3 also represents a scanning electron microscope photograph of a lithium-rich material for a positive electrode,

FIG. 4 represents a scanning electron microscope photograph of a graphite-based material for a negative electrode.

In the description of the invention, the terms “based on” or “-based” are synonymous with “predominantly comprising”.

The Li-ion batteries generally comprise a positive electrode, a negative electrode, a separator between the electrodes and an electrolyte comprising lithium ions. During a charge cycle of a Li-ion battery, the lithium ions move toward the negative electrode while passing through a separator. During the discharge cycle, the same ions move from the negative electrode toward the positive electrode while again passing through a separator.

The Li-ion battery according to the invention is designed so that said battery exhibits an N/P ratio=1.

The Li-ion battery according to the invention comprises a lithium-rich material for a positive electrode. Said lithium-rich material for a positive electrode comprises an active material which is generally a lithium metal oxide of a metal chosen from nickel, cobalt and/or manganese and optionally another doping metal. The active lithium-rich material for a positive electrode is of formula Li₁₊ₓ(MₐD_{b})₁₋ₓO₂, in which M represents a metal or several metals chosen from nickel, manganese and cobalt, x is between 0.01 and 0.33, D represents a doping metal or several doping metals chosen from Na, Zn, Cd, Mg, Ti, Ca, Zr, Sr, Ba, Al or K, b is between 0 and 0.05 and a+b=1.

Besides the active material, the lithium-rich material for a positive electrode can also comprise carbon fibers. Preferably, these are vapor grown carbon fibers (VGCFs) sold by Showa Denko. Other appropriate types of carbon fibers can be carbon nanotubes, doped nanotubes (optionally doped with graphite), carbon nanofibers, doped nanofibers (optionally doped with graphite), single-walled carbon nanotubes or multi-walled carbon nanotubes. The methods of synthesis relating to these materials can include arc discharge, laser ablation, a plasma torch and chemical vapor decomposition.

The lithium-rich material for a positive electrode can additionally comprise one or more binders.

Preferably, the binder or binders can be chosen from polybutadiene/styrene latexes and organic polymers and preferably from polybutadiene/styrene latexes, polyesters, polyethers, polymer derivatives of methyl methacrylate, polymer derivatives of acrylonitrile, carboxymethylcellulose and its derivatives, polyvinyl acetates or polyacrylate acetate, polyvinylidene fluorides, and their mixtures.

The Li-ion battery according to the invention comprises a graphite-based material for a negative electrode. The graphite carbon can be chosen from synthetic graphite carbons and natural graphite carbons, starting from natural precursors, followed by purification and/or a post treatment. Other active materials based on carbon can be used, such as pyrolytic carbon, amorphous carbon, active charcoal, coke, coal pitch and graphene. Mixtures of graphite with one or more of these materials are possible. Materials having a core/shell structure can be used when the core comprises high-capacity graphite and when the shell comprises a material based on carbon which protects the core from the degradation related to the repeated phenomenon of the intercalation/deintercalation of the lithium ions.

The graphite-based material for a negative electrode can additionally comprise one or more binders as for the positive electrode.

The binders described above for the positive electrode can be used for the negative electrode.

The Li-ion battery according to the invention also comprises a separator located between the electrodes. It acts as electrical insulator. Several materials can be used as separators. The separators are generally composed of porous polymers, preferably of polyethylene and/or of polypropylene.

The Li-ion battery according to the invention also comprises an electrolyte, preferably a liquid electrolyte.

This electrolyte generally comprises one or more lithium salts and one or more solvents.

The lithium salt or salts generally comprise inert anions. Appropriate lithium salts can be chosen from lithium bis[(trifluoromethyl)sulfonyl]imide (LiN(CF₃SO₂)₂), lithium trifluoromethane-sulfonate (LiCF₃SO₃), lithium bis(oxalato)borate (LiBOB), lithium difluoro(oxalato)borate (LiDFOB), lithium bis(perfluoroethylsulfonyl)imide (LiN(CF₃CF₂SO₂)₂), LiClO₄, LiAsF₆, LiPF₆, LiBF₄, LiI, LiCH₃SO₃, LiB(C₂O₄)₂, LiR_{F}SOSR_{F}, LiN(R_{F}SO₂)₂ and LiC(R_{F}SO₂)₃, R_{F} being a group chosen from a fluorine atom and a perfluoroalkyl group comprising between one and eight carbon atoms.

The lithium salt or salts are preferably dissolved in one or more solvents chosen from polar aprotic solvents, for example ethylene carbonate (denoted “EC”), propylene carbonate, dimethyl carbonate, diethyl carbonate (denoted “DEC”) and ethyl methyl carbonate.

Another subject matter of the invention is a process for the preparation of Li-ion batteries according to the invention, comprising the following stages:
manufacture of a cell, comprising the following stages:
   preparation of a first electrode by deposition, on a current collector, of a given weight of a graphite-based material for a negative electrode as defined above,
   preparation of a second electrode by deposition, on a current collector, of an appropriate weight, so that the equation (1) as defined below:

$$N \text{/} P = \frac{{Q}_{rev}^{-}}{{Q}_{rev}^{+}} = \frac{{L}^{-} \times {Q}_{spe . rev}^{-}}{{L}^{+} \times {Q}_{spe . rev}^{+}} \qquad ( 1 )$$

in which Q⁻ᵣₑᵥ denotes the reversible surface capacity of the negative electrode (mAh/cm²);

Q⁺ᵣₑᵥ denotes the reversible surface capacity of the positive electrode (mAh/cm²);

L⁻ denotes the weight per unit of surface area of active material for the negative electrode (mg/cm²);

L⁺ denotes the weight per unit surface area of active material for the positive electrode (mg/cm²);

Q⁻_{spe.rev} denotes the specific reversible capacity of the negative electrode (mAh/mg);

Q⁺_{spe.rev} denotes the specific reversible capacity of the positive electrode (mAh/mg),
is observed for an N/P ratio=1, of a lithium-rich material for a positive electrode as defined above;

in other words, knowing the weight of material for the negative electrode deposited and the values of Q⁻_{spe.rev}, Q⁺_{spe.rev} and L⁻, a person skilled in the art is capable of finding the weight of material for the positive electrode to be deposited so that the N/P ratio is equal to 1;
stacking the first electrode as prepared above, the second electrode as prepared above and a separator as described above, located between the two electrodes,
impregnating the separator with an electrolyte as described above,
assembling one or more cell(s) as manufactured above.

It should be noted that the two stages of preparation of the electrodes by deposition are invertible.

In a preferred embodiment, a process for the preparation of Li-ion batteries according to the invention comprises the following stages:
manufacture of a cell, comprising the following stages:
   preparation of a first electrode by deposition, on a current collector, of a given weight of a graphite-based material for a negative electrode as defined above,
   drying said first electrode,
   densifying said first electrode,
   preparation of a second electrode by deposition, on a current collector, of an appropriate weight, so that the equation (1) is observed for an N/P ratio=1, of a lithium-rich material for a positive electrode as defined above,
   drying said second electrode,
   densifying said second electrode,
   stacking the first electrode as prepared above, and the second electrode as prepared above and a separator as described above, located between the two electrodes,
   impregnating the separator with an electrolyte as described above,
assembling one or more cell(s) as manufactured above.

It should be noted that the two stages of preparation of the electrodes are invertible.

Another subject matter of the invention is a specific process for the cycling of a Li-ion battery according to the invention comprising the following stages:
a first activation cycle between an upper voltage (Tᵤₚₚ) of strictly greater than 4.40 V, preferably between 4.40 V, limit excluded, and 4.60 V, and a lower voltage (T_{low}) of between 1.60 and 2.50 V, preferably equal to 2 V,
the following charge and discharge cycles at voltages between a voltage Tᵤₚₚ of between 4.30 and 4.43 V, preferably equal to 4.40 V, and a voltage T_{low} of between 1.60 and 2.50 V, preferably equal to 2.30 V;
   the cycles being carried out at a capacity of between C/20 and C, C denoting the capacity of the Li-ion battery.

In a preferred embodiment, the first activation cycle is carried out at a capacity of C/10.

In another preferred embodiment, the following charge and discharge cycles are carried out at a capacity of C/2.

During the cycling process according to the invention, a high voltage is used during the activation cycle. This “excess voltage” can be likened to the additional capacity of the lithium-rich material for a positive electrode. Said material is used as a “sacrificial lithium” material during this stage in order to form the SEI on the active graphite-based material for a negative electrode.

The present invention is illustrated without implied limitation by the following examples.

### EXAMPLES

### Preparation of the Positive Electrode

An active lithium-rich material for a positive electrode is provided by Umicore and has the formula Li_{1.2}Mn_{0.5}Ni_{0.2}CO_{0.1}O₂. The positive electrode is prepared by mixing 86% by weight of active material, 3% by weight of a Super P® carbon additive, 3% by weight of carbon fibers (VGCFs) and 8% by weight of polyvinylidene fluorine dissolved in N-methyl-2-pyrrolidone (NMP).

Two types of electrode are prepared, one by way of comparison and one according to the invention. The two electrodes are manufactured by respectively depositing the mixture on an aluminum sheet with a thickness of 20 μm. The electrodes are dried and compressed by calendering at 80° C. so that they each exhibit a porosity of 35%.

In order for the density of material for an electrode to be 5.65 mg/cm², a value governed by the equation (1), the final thickness of said material for an electrode for the Li-ion battery exhibiting an N/P ratio=1.26 is 52 μm.

In order for the density of material for an electrode to be 8.15 mg/cm², a value governed by the equation (1), the final thickness of said material for an electrode for the Li-ion battery exhibiting an N/P ratio=1 is 60 μm.

FIGS. 2 and 3 represent scanning electrode microscope photographs of the positive electrode thus manufactured.

Preparation of the Negative Electrode

An active graphite material is provided by Hitachi (SMGHE2). Two types of electrode are prepared, one by way of comparison and one according to the invention, by mixing 96% by weight of graphite, 2% by weight of carboxymethylcellulose (CMC) and 2% by weight of Styrofan® latex, that is to say a carboxylated styrene/butadiene copolymer.

The resulting mixture is respectively deposited on a copper sheet with a thickness of 15 μm, then dried and compressed by calendering at 80° C. The negative electrodes thus manufactured each exhibit a porosity of 43%.

In order for the density of material for an electrode to be 4.46 mg/cm², the final thickness of said material for an electrode for the Li-ion battery exhibiting an N/P ratio=1.26 is 41 μm.

In order for the density of material for an electrode to be 5.05 mg/cm², the final thickness of said material for an electrode for the Li-ion battery exhibiting an N/P ratio=1 is 46 μm.

FIG. 4 represents a scanning electron microscope photograph of the positive electrode thus manufactured.

Characteristics of the Electrodes

The detailed characteristics of the electrodes are presented in table 1 below:

TABLE 1

| | Comparative | Invention |
|---|---|---|
| | A (N/P = | B (N/P = |
| Type of battery | 1.26) | 1) |
| Positive electrode | | |
| Area of the electrode | 10.24 | 10.24 |
| (cm²) | | |
| Total weight per unit of | 5.65 | 8.15 |
| surface area (mg/cm²) | | |
| Theoretical reversible | 250 | 250 |
| specific capacity at | | |
| C/10 vs Li metal (mAh/g) | | |
| Irreversible capacity at | 12 | 12 |
| C/10 vs Li metal (%) | | |
| Specific reversible | 256.3 | 252.3 |
| capacity at C/10 (mAh/g) | | |
| Specific reversible | 1.25 | 1.77 |
| surface capacity at C/10 | | |
| (mAh/cm²) | | |
| Negative electrode | | |
| Area of the electrode | 12.25 | 12.25 |
| (cm²) | | |
| Total weight (mg/cm²) | 4.46 | 5.05 |
| Theoretical specific | 370 | 370 |
| reversible capacity at | | |
| C/10 vs Li metal (mAh/g) | | |
| Irreversible capacity at | 15 | 16 |
| C/10 vs Li metal (%) | | |
| Specific reversible | 370 | 366 |
| capacity at C/10 (mAh/g) | | |
| Specific reversible | 1.58 | 1.77 |
| surface capacity at C/10 | | |
| (mAh/cm²) | | |

As regards the comparative Li-ion battery A, table 1 shows that the positive electrode is designed so that a specific reversible surface capacity of 1.25 mAh/cm² is measured. A specific reversible surface capacity of 1.58 mAh/cm² is measured for the negative electrode. Thus, the battery A exhibits an N/P ratio=1.26.

As regards the Li-ion battery B of the invention, table 1 shows that the positive electrode is designed so that a specific reversible surface capacity of 1.77 mAh/cm² is measured. The specific reversible surface capacity of 1.77 mAh/cm² is measured for the negative electrode. Thus, the battery B exhibits an N/P ratio=1.

Separator and Electrolyte

The Celgard® 2500 separator is used in order to prevent any short circuit between the positive electrode and the negative electrode during the charge and discharge cycles. The area of this separator is 16 cm².

The electrolyte used is a mixture of ethylene carbonate, ethyl methyl carbonate and dimethyl carbonate (EC/EMC/DMC) according to a 1/1/1 ratio by volume with the lithium salt LiPF₆ at 1M.

The Celgard® 2500 separator is a monolayer microporous membrane with a thickness of 25 μm composed of polypropylene.

Electrochemical Performances of Li-Ion Battery Cells

FIG. 1 represents a graph comparing the specific discharge capacities of three cells of Li-ion batteries each comprising a lithium-rich material for a positive electrode and a graphite-based material for a negative electrode and exhibiting different N/P ratios as a function of the charge and discharge cycle number. The cell of the battery A exhibits an N/P ratio=1.26. The cell of the battery B exhibits an N/P ratio=1, that is to say that it is designed according to the invention. The cell of the battery C exhibits an N/P ratio=1.26.

Two different cycling processes were used. As regards the cell of the battery A, an initial voltage of 4.6 V was used during the activation cycle at a capacity C/10. The following charge and discharge cycles took place at voltages of between 4.6 and 2.3 V at a capacity C/2. On the other hand, while the initial voltage of 4.6 V was used during the activation cycle for the cells of the battery B and of the battery C at a capacity C/10, the following charge and discharge cycles took place at reduced voltages of between 4.4 and 2.3 V at a capacity C/2.

Thus, if the initial voltage of 4.6 V is not reduced for the following charge and discharge cycles, FIG. 1 clearly shows that the electrochemical behavior (curve A) is very unstable as regards the cell of the battery A. A fall in the electrochemical performances is observed and a specific discharge capacity of approximately 100 mAh/g is measured after approximately 150 cycles.

FIG. 1 moreover shows that the electrochemical performances (respectively curves B and C) of the cells of the battery B and of the battery C are similar after approximately 180 cycles. Specifically, a specific discharge capacity of approximately 150 mAh/g is measured for the two cells.

The analysis of FIG. 1 thus shows first of all that, by using the cycling process according to the invention, a marked improvement in the electrochemical performances is observed. In addition, it results from the analysis of FIG. 1 that it is no longer necessary to put graphite in excess into a Li-ion battery cell. Consequently, the energy density of the cell is increased.

1. A lithium-ion battery comprising:
a graphite-based material for a negative electrode;
a lithium-rich material for a positive electrode;
a separator; and
an electrolyte,
wherein a reversible capacity (N) of said negative electrode is equal to a reversible capacity (P) of said positive electrode so that said battery exhibits an N/P ratio=1.

2. The battery as claimed in claim 1, wherein said lithium-rich material for a positive electrode comprises an active material of formula Li₁₊ₓ(MₐD_{b})₁₋ₓO₂, in which M represents a metal or several metals chosen from nickel, manganese and cobalt, x is between 0.01 and 0.33, D represents a doping metal or several doping metals chosen from Na, Zn, Cd, Mg, Ti, Ca, Zr, Sr, Ba, Al or K, b is between 0 and 0.05 and a+b=1.

3. The battery as claimed in claim 1, wherein said lithium-rich material for a positive electrode comprises carbon fibers.

4. The battery as claimed in claim 3, wherein the carbon fibers are vapor grown carbon fibers (VGCFs).

5. The battery as claimed in claim 1, wherein said lithium-rich material for a positive electrode comprises one or more binders.

6. The battery as claimed in claim 5, wherein said binder or binders are chosen from polybutadiene/styrene latexes and organic polymers.

7. The battery as claimed in claim 1, wherein said graphite-based material for a negative electrode comprises one or more binders.

8. The battery as claimed in claim 1, wherein said separator is generally composed of porous polymers.

9. The battery as claimed in claim 1, wherein said electrolyte comprises one or more lithium salts.

10. The battery as claimed in claim 9, wherein said or said several lithium salts are chosen from lithium bis[(trifluoromethyl)sulfonyl]imide (LiN(CF₃SO₂)₂), lithium trifluoromethanesulfonate (LiCF₃SO₃), lithium bis(oxalato)borate (LiBOB), lithium difluoro(oxalato)borate (LiDFOB), lithium bis(perfluoroethylsulfonyl)imide (LiN(CF₃CF₂SO₂)₂), LiClO₄, LiAsF₆, LiPF₆, LiBF₄, LiI, LiCH₃SO₃, LiB(C₂O₄)₂, LiR_{F}SOSR_{F}, LiN(R_{F}SO₂)₂ and LiC(R_{F}SO₂)₃, R_{F} being a group chosen from a fluorine atom and a perfluoroalkyl group comprising between one and eight carbon atoms.

11. The battery as claimed in claim 1, wherein said electrolyte comprises one or more solvents.

12. The battery as claimed in claim 11, wherein said or said several solvents are chosen from polar aprotic solvents.

13. A process for the preparation of the Li-ion battery as claimed in claim 1, said process comprising:
manufacturing a cell, comprising the following stages:
preparation of a first electrode by deposition, on a current collector, of a given weight of a graphite-based material for a negative electrode, and
preparation of a second electrode by deposition, on a current collector, of an appropriate weight, so that the equation (1) as defined below:
$$N \text{/} P = \frac{{Q}_{rev}^{-}}{{Q}_{rev}^{+}} = \frac{{L}^{-} \times {Q}_{spe . rev}^{-}}{{L}^{+} \times {Q}_{spe . rev}^{+}} \qquad ( 1 )$$
in which Q⁻ᵣₑᵥ denotes the reversible surface capacity of the negative electrode (mAh/cm²);
Q⁺ᵣₑᵥ denotes the reversible surface capacity of the positive electrode (mAh/cm²);
L⁻ denotes the weight per unit of surface area of active material for the negative electrode (mg/cm²);
L¹ denotes the weight per unit surface area of active material for the positive electrode (mg/cm²);
Q⁻_{spe.rev} denotes the specific reversible capacity of the negative electrode (mAh/mg);
Q⁺_{spe.rev} denotes the specific reversible capacity of the positive electrode (mAh/mg),
is observed for an N/P ratio=1, of a lithium-rich material for a positive electrode as defined above;
the preparation of said first electrode and the preparation of said second electrode being invertible,
stacking the first electrode, the second electrode and a separator, located between the two electrodes,
impregnating the separator with an electrolyte, and assembling one or more of the cells.

14. A process for cycling of the Li-ion battery as claimed in claim 1, said process comprising:
carrying out a first activation cycle between a voltage Tᵤₚₚ of strictly greater than 4.40 V, and a voltage T_{low} of between 1.60 and 2.50 V;
carrying out following charge and discharge cycles at voltages between a voltage Tᵤₚₚ of between 4.30 and 4.43 V, and a voltage T_{low} of between 1.60 and 2.50 V,
the cycles being carried out at a capacity of between C/20 and C, C denoting the capacity of the Li-ion battery.

15. The process as claimed in claim 14, wherein said first activation cycle is carried out at a capacity of C/10.

16. The process as claimed in claim 14, wherein said following charge and discharge cycles are carried out at a capacity of C/2.

17. The battery as claimed in claim 5, wherein said binder or binders are chosen from polybutadiene/styrene latexes, polyesters, polyethers, polymer derivatives of methyl methacrylate, polymer derivatives of acrylonitrile, carboxymethylcellulose and its derivatives, polyvinyl acetates or polyacrylate acetate, polyvinylidene fluoride polymers and their mixtures.

18. The battery as claimed in claim 1, wherein said separator is generally composed of polyethylene and/or of polypropylene.

19. The battery as claimed in claim 11, wherein said or said several solvents are chosen from ethylene carbonate, propylene carbonate, dimethyl carbonate, diethyl carbonate and ethyl methyl carbonate.

20. The process as claimed in claim 14, wherein the first activation cycle is carried out between the voltage Tᵤₚₚ of between 4.40 V, limit excluded, and 4.60 V.
